(19) United States
(12) Patent Application Publication
(10) Pub. No.: US 2016/0044525 A1
(43) Pub. Date: Feb. 11, 2016

(54) METHOD OF PROVIDING INFORMATION ON A SERVER STATUS, USER EQUIPMENT, AND COMMUNICATION SYSTEM

(71) Applicant: Sony Corporation, Tokyo (JP)

(72) Inventors: Saif Alnashi, Staffanstorp (SE); Samir Drincic, Lund (SE)

(21) Appl. No.: 14/737,607

(22) Filed: Jun. 12, 2015

Related U.S. Application Data
(63) Continuation of application No. PCT/EP2014/066803, filed on Aug. 5, 2014.

(51) Int. Cl. H04W 28/02; H04W 4/00

(52) U.S. Cl. CPC H04W 28/0215; H04W 4/008; H04W 4/005; H04W 88/06

(57) ABSTRACT

A user equipment configured for communication with a cellular network determines a server status of a third party server which is not under the control of a cellular network operator. The user equipment transmits information on the server status to at least one further user equipment by device-to-device communication.

### FIELD OF THE INVENTION

Embodiments of the invention relate to communication systems. Embodiments of the invention relate in particular to techniques for providing information on a server status of a third party server to devices which are configured to interact with the third party server over the cellular network.

### BACKGROUND OF THE INVENTION

The demand for mobile data and voice communication continues to evidence significant growth. Examples for mobile communication systems include cellularbased wireless communication networks. Such networks include various network nodes. The network nodes may include base stations which respectively provide coverage for a radio cell.

A user equipment of a cellular network may be a Proximity Service (ProSe) enabled device. Several ProSe enabled user equipments which are located in proximity to each other are operative to perform device-to-device (D2D) communication. D2D communication allows user equipments of a cellular network to directly communicate with each other when the user equipments are located in proximity to each other. D2D communication has a wide variety of applications, including public safety and other use cases. Emergency calls are one example for public safety use cases of D2D communication.

Modern terminals of a communication network, e.g. smart phones or machine type communication terminals, have advanced processing capabilities. The terminals can run a wide variety of applications. These applications include social networks, e-mail services, update clients such as news update centers or weather forecasts, monitoring and control functions which rely upon sensor outputs of a terminal, without being limited thereto.

With the spread of applications on user equipments and the ever growing number of user equipments designed for machine type communications, the risk increases that issues occur in which a third party server which assists user equipment(s) in the execution of an application fails, is congested, or has reduced availability for other reasons. The third party server may be dedicated to a particular user equipment application or it may support multiple user equipment applications.

In such scenarios there is a risk that the applications on the user equipments continue to make connection attempts to the third party server, e.g. by pinging the third party server. This behavior may increase network loads and may increase the congestion of the third party server.

### SUMMARY OF THE INVENTION

There is a need in the art for techniques which mitigate at least some of the above shortcomings. There is in particular a need in the art for methods, devices and systems in which information on a server status can be distributed in an efficient way when a user equipment is informed that a third party server experiences problems, as may be the case for a server failure or a congestion.

According to exemplary embodiments, a user equipment may transmit information on a server status of a third party server using device-to-device communication to at least one further user equipment. The information on the server status may thereby be distributed efficiently, without significantly increasing the loads on a radio access network of a mobile communication network.

The user equipment may receive information on the server status in a message through a cellular network. The message may be generated by the third party server itself or by a cellular network node of the cellular network. The user equipment may generate a device-to-device communication message which includes the information on the server status in response to receiving the message.

According to an embodiment, a method of providing information on a server status of a third party server is performed using a user equipment of a cellular communication network. The user equipment determines the server status of the third party server. The user equipment transmits the information on the server status to at least one further user equipment by device-to-device communication.

The user equipment may comprise a wireless interface for communication with the cellular network. The user equipment may determine the server status by receiving a message indicative of the server status at the wireless interface.

The user equipment may transmit the information on the server status to the at least one further user equipment over the wireless interface. The same wireless interface may thereby be used for both receipt of the message indicating the server status and transmission of the device-to-device communication.

The message received by the user equipment may be indicative of at least one of a congestion or a failure of the third party server.

The user equipment may interact with the third party server for executing an application. The application may cause the user equipment to transmit application messages to and/or receive application messages from the third party server.

In response to receiving a message indicative of the congestion or failure of the third party server, the user equipment may reduce communication attempts to the third party server. The user equipment may increase a minimum time interval between successive transmissions to the third party server.

The user equipment may transmit an identifier for the application to the at least one further user equipment in the device-to-device communication message. This allows the application affected by the server status to be identified.

The message received by the user equipment may be generated by the third party server. The third party server may thereby inform the user equipment of problems as long as the third party server is still capable of doing so, and this information is distributed further by the user equipment by device-to-device communication.

The message received by the user equipment may be generated by a cellular network node. The cellular network node may detect a failure or congestion of the third party server by monitoring data traffic through the cellular network. The cellular network node may have an interface for receiving an indication from the third party server which indicates a congestion or failure status of the third party server. The cellular network node may be triggered to generate the message for transmission to the user equipment by receipt of a status indication from the third party server. The cellular network node may generate the message for transmission to the user equipment such that the application executed at the user equipment receives information which allows the communication with the third party server to be adjusted in accordance with the status.

The user equipment may relay at least one information element of the message as the information on the server status to the at least one further user equipment.

The user equipment may generate and transmit a device-to-device communication message which includes the information on the server status.

The at least one further user equipment may selectively adjust communication with the third party server based on the information on the server status.

The user equipment may generate the device-to-device communication message such that it includes the information on the server status and time information. The time information may be a time stamp. The time information may define a validity time for the information on the server status.

The at least one further user equipment may selectively adjust communication with the third party server based on the time information and the information on the server status. For illustration, the at least one further user equipment may selectively reduce the rate at which pinging messages or other messages are sent to the third party server in response to the device-to-device communication message when the device-to-device communication message indicates that the third party server has a server failure or is congested.

The user equipment may generate the device-to-device communication message such that it includes a replacement identifier to update previous information on the server status which was previously transmitted by the user equipment or by another user equipment.

The user equipment may determine whether the information on the server status is to replace a previous information on the server status which was previously transmitted to the at least one further user equipment. The user equipment may include a replacement identifier identifying the previous information in the device-to-device communication message.

The user equipment may be a cellular phone.

The user equipment may be a machine-communication terminal.

A user equipment according to an embodiment is configured to interact with a third party server through a cellular network. The user equipment comprises a wireless interface configured for communication with the cellular network. The user equipment comprises a processing device configured to control the wireless interface to provide information on a server status of the third party server to at least one further user equipment by device-to-device communication.

The server status may comprise a server failure status of the third party server. The server status may comprise a server congestion status of the third party server.

The user equipment may be configured to determine the server status by receiving a message indicative of the server status at the wireless interface.

The user equipment may be configured to transmit the information on the server status to the at least one further user equipment over the wireless interface.

The user equipment may be configured to interact with the third party server for executing an application. The application may cause the user equipment to transmit application messages to and/or receive application messages from the third party server.

In response to receiving a message indicative of the congestion or failure of the third party server, the user equipment may be configured to reduce communication attempts to the third party server. The user equipment may be configured to increase a minimum time interval between successive transmissions to the third party server.

The user equipment may be configured to transmit an identifier for the application to the at least one further user equipment in the device-to-device communication message.

The user equipment may be configured to receive the message indicative of the server status from the third party server.

The user equipment may be configured to receive the message indicative of the server status from a cellular network node.

The user equipment may be configured to relay at least one information element of the message as the information on the server status to the at least one further user equipment.

The user equipment may be configured to generate and transmit a device-to-device communication message which includes the information on the server status.

The user equipment may be configured to generate the device-to-device communication message such that it includes the information on the server status and time information. The time information may be a time stamp. The time information may define a validity time for the information on the server status.

The user equipment may be configured to generate the device-to-device communication message such that it includes a replacement identifier to update previous information on the server status which was previously transmitted by the user equipment or by another user equipment.

The user equipment may be configured to determine whether the information on the server status is to replace a previous information on the server status which was previously transmitted to the at least one further user equipment. The user equipment may be configured to include a replacement identifier identifying the previous information in the device-to-device communication message.

The user equipment may be a cellular phone.

The user equipment may be a machine-communication terminal.

A further user equipment according to an embodiment comprises a further wireless interface configured for communication with a cellular network. The further user equipment is configured to receive the information on the server status as device-to-device communication at the further wireless interface. The further user equipment is configured to control communication attempts with a third party server in dependence on the information on the server status.

The further user equipment may be configured to selectively adjust a rate of communication attempts with the third party server based on the information on the server status.

The further user equipment may be configured to selectively suspend communication attempts with the third party server when the information on the server status indicates that there is a server failure or congestion.

The further user equipment may be configured to determine a time for which the communication with the third party server is reduced based on time information included in a device-to-device communication message received from the user equipment.

A communication system according to an embodiment comprises a user equipment according to an embodiment. The communication system comprises a further user equipment comprising a further wireless interface configured for communication with the cellular network. The further user equipment is configured to receive the information on the server status at the further wireless interface. The further user equipment is configured to control communication attempts with the third party server in dependence on the information on the server status.

The further user equipment may be configured to adjust a time interval between successive communication attempts with the third party server in dependence on the information on the server status.

The further user equipment may be the further user equipment according to any embodiment.

The user equipment may be configured to execute an application. The application may interact with the third party server. The further user equipment may be configured to execute the application which may interact with the third party server.

The communication system may further comprise a cellular network.

The communication system may further comprise a third party server. The third party server may be configured to interact with an application executed by the user equipment and/or with an application executed by the further user equipment.

The third party server may be configured to generate a message including an indication for a server status for transmission to the user equipment. The third party server may additionally or alternatively be configured to communicate with a cellular network node of the cellular network to provide information indication for a server status of the third party server to the cellular network node.

The communication system may further comprise a cellular network node of the cellular network, with the cellular network node being configured to receive the indication for a server status from the third party server. The cellular network node may be configured to generate a message which includes information on the server status and to transmit the message to the user equipment through the cellular network.

The communication system may be configured to perform the method according to any embodiment.

The methods, devices, and systems according to various embodiments provide a mechanism which allows information on a server status to be distributed while mitigating problems associated with increasing network loads which may conventionally occur when the third party server experiences problems.

Although specific features described in the above summary and the following detailed description are described in the context of specific embodiments and aspects of the invention, the features of the embodiments and aspects may be combined with each other unless specifically noted otherwise.

### BRIEF DESCRIPTION OF THE DRAWINGS

Embodiments of invention will now be described in more detail with reference to the accompanying drawings in which like or identical reference numerals designate like or identical elements.

FIG. 1 shows a communication system according to an embodiment.

FIG. 2 shows a communication system according to an embodiment.

FIG. 3 is a block diagram representation of a communication system according to an embodiment.

FIG. 4 is a flow chart of a method according to an embodiment.

FIG. 5 is a device-to-device communication message which may be transmitted by a user equipment according to an embodiment to distribute information on a server status.

FIG. 6 is a device-to-device communication message which may be transmitted by a user equipment according to an embodiment to distribute information on a server status.

FIG. 7 is a device-to-device communication message which may be transmitted by a user equipment according to an embodiment to distribute information on a server status.

FIG. 8 is a flow chart of a method performed by a further user equipment according to an embodiment.

FIG. 9 is a signal flow diagram between devices of a communication system according to an embodiment.

FIG. 10 is a signal flow diagram between devices of a communication system according to an embodiment.

FIG. 11 is a functional block diagram of a cellular network node according to an embodiment.

### DETAILED DESCRIPTION OF PREFERRED EMBODIMENTS

In the following, exemplary embodiments of the invention will be described in more detail. It is to be understood that the features of the various exemplary embodiments described herein may be combined with each other unless specifically noted otherwise. Identical or similar reference numerals refer to identical or similar components.

While exemplary embodiments will be described with reference to certain use cases for interaction between applications executed on user equipments and a third party server, it is to be understood that the techniques for providing information on a server status may be used for a wide variety of use cases, including applications executed by handheld phones and applications executed by machine communication terminals. While exemplary embodiments will be described in the context of certain cellular mobile communication networks, e.g. Long Term Evolution (LTE) networks, and corresponding message structures, the embodiments are not limited to such mobile communication techniques.

According to embodiments, a user equipment which has a wireless interface for communication with a cellular network may execute an application. Execution of the application may involve transmission of application messages to a third party server and/or receipt of application messages from the third party server. The third party server may support the user equipment upon execution of the application.

The user equipment may be operative to determine a server status, e.g. by receiving a message which is indicative of the server status. The user equipment may be configured to at least determine whether the third party server experiences a server failure and/or whether the third party server experiences a congestion.

The user equipment may transmit a device-to-device communication message to at least one further user equipment to inform the at least one further user equipment of the server status. The at least one further user equipment may be located in proximity to the user equipment.

The device-to-device communication message may be transmitted over the wireless interface which the user equipment also uses for communication with the cellular network. The device-to-device communication message may be transmitted in resources allocated by the cellular network. The device-to-device communication message may be transmitted in periodic uplink resources. The device-to-device communication message may be transmitted directly between the user equipment and the at least one further user equipment, without being processed in a radio access network of the cellular network.

By using device-to-device communication for distributing information on a server status, problems associated with high network loads upon server failure or server congestion may be mitigated.

As used herein, the term “third party server” is used to refer to a server which is not under the control of the cellular network operator. The “third party server” may in particular be a server connected to a wide area network (WAN) such as the internet.

According to conventional terminology in the art, the term “device-to-device communication” is used to refer to direct communication between a user equipment and a further user equipment, which may in particular be performed using the wireless interface configured for communication with the radio access network of the cellular network.

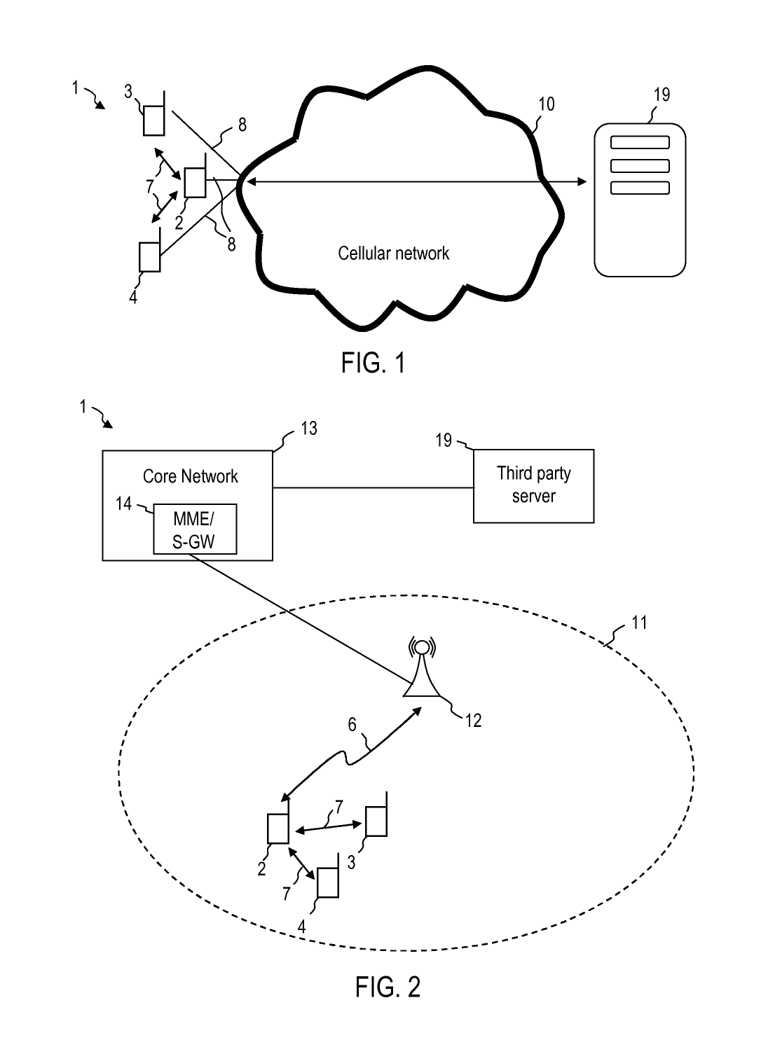

FIG. 1 shows a communication system 1 according to an embodiment. The communication system 1 includes a cellular network 10. A user equipment 2 is configured for communication with the cellular network 10. The user equipment 2 may execute an application. The user equipment 2 may transmit and/or receive data over a network connection 8 between the third-party server 19 and the user equipment 2. The data over the network connection 8 between the third-party server 19 and the user equipment 2 may be associated with the execution of the application.

At least one further user equipment 3, 4 may respectively also execute the application. The at least one further user equipment 3, 4 may transmit and/or receive data over a network connection 8 between the third-party server 19 and the at least one further user equipment 3, 4. The data over the network connection 8 between the third-party server 19 and the at least one further user equipment 3, 4 may be associated with the execution of the application.

The user equipment 2 may use device-to-device communication 7 to inform the at least one further user equipment 3, 4 of the server status of the third party server 19. The user equipment 2 may generate a device-to-device communication message and may transmit the a device-to-device communication message to the at least one further user equipment 3, 4 in response to detecting that the server status of the third party server is a failure status indicating a failure. The user equipment 2 may generate a device-to-device communication message and may transmit the a device-to-device communication message to the at least one further user equipment 3, 4 in response to detecting that the server status of the third party server is a congestion status indicating a congestion.

The device-to-device communication 7 may be performed directly between the user equipment 2 and the at least one further user equipment 3, 4, without forwarding of the device-to-device communication by a radio access network (RAN) of the cellular network 10.

FIG. 2 shows a communication system 1 according to an embodiment. The communication system 1 comprises a cellular network. The cellular network may comprise a plurality of base stations. A base station 12 is shown in FIG. 2. Each base station may provide coverage for a cell 11. The base stations may communicate with each other via wireless radio communications or via an operator core network 13. The cellular network may be a Long Term Evolution (LTE) network. A radio access network (RAN) of the cellular network may be an evolved UTRAN (E-UTRAN), with the base stations respectively being an evolved Node B (eNodeB). The base station 12 may be connected to a Mobility Management Entity (MME) and/or Serving Gateway (S-GW) 14 in the operator core network 13.

The base station 12 provides a radio cell 11 in which user equipments (UEs) 2, 3 may communicate directly with the base station 12 via radio frequency communication 6. The user equipment (UE) 2 and the at least one further UE 3, 4 may respectively have a wireless interface for communication with the E-UTRAN.

The UE 2 and at least one further UE 3, 4 are capable of performing a device-to-device (D2D) discovery for D2D communication. According to the terminology in the pertinent field of the art, the term D2D communication refers to a radio communication between the UE 2 and the at least one further UE 3, 4 which is performed directly between these devices. The radio signals 7 transmitted in the D2D discovery and communication may not be processed by the base station 12. The radio signals 7 transmitted in the D2D discovery and communication may not pass the RAN of the communication network. The radio signals 7 transmitted in the D2D discovery and communication may not be processed by a core network of the wireless cellular network. The UE 2 and the at least one further UE 3, 4 which are configured for D2D communication and discovery may respectively use the same wireless interface for communicating with the RAN and for D2D communication.

A UE 2 configured for D2D discovery and D2D communication may also be referred to as Proximity Service (ProSe)-enabled UE in the art. Not all UEs communicating with the wireless cellular network need to be configured for D2D discovery and D2D communication.

The UE 2 and the at least one further UE 3, 4 may use periodic uplink resources for D2D discovery and/or D2D communication. The resources may be divided in the time domain, e.g. according to time division multiplexing (TDM), and/or in the frequency domain, e.g. according to frequency division multiplexing (FDM). The UE 2 and the at least one further UE 3, 4 may use at least one physical resource block for the D2D discovery and/or communication which would otherwise be used for uplink communication. The resources for the D2D discovery and/or communication may be allocated by the cellular network. The allocated resources for the D2D discovery and/or communication may be allocated to the UE 2 and the at least one further UE 3, 4 by the base station 12. The allocated resources may respectively be allocated in a semi-static manner.

Both the UE 2 and the at least one further UE 3, 4 may execute an application. The application may interact with the third party server 19. Application data may be transmitted between the UE 2 and the third party server 19 through the cellular network 10. The UE 2 may have established a network connection with the third party server 19 over which the application data are transmitted. Application data may be transmitted between the at least one further UE 3, 4 and the third party server 19 through the cellular network 10. The at least one further UE 3, 4 may have established a network connection with the third party server 19 over which the application data are transmitted.

The UE 2 may determine a server status of the third party server. Determining the server status may be based on a message received from the third party server 19 itself or from a node in the cellular network. Determining the server status may alternatively or additionally comprise monitoring the behavior of the third party server 19 by the UE 2. For illustration, the UE 2 may monitor response times of the third party server 19. The UE 2 may monitor ping response times of the third party server 19.

The UE 2 may be configured such that it is capable of determining whether the third party server 19 has a server status which corresponds to a server failure and/or a server status which corresponds to a server congestion. The UE 2 may be configured to determine whether the third party server 19 has a server status which makes it desirable that not only the UE 2, but also the at least one further UE 3, 4 reduces communication with the third party server 19 to mitigate problems associated with spurious network loads which would occur when the third party server 19 is unable to respond.

In response to determining that the third party server 19 has such as server status, the UE 2 may transmit information on the server status by device-to-device communication. The UE 2 may generate a device-to-device communication message 7 which includes information on the server status and which causes the at least one further UE 3, 4 to reduce communication attempts with the third party server 19 at least for a time interval subsequent to receipt of the device-to-device communication message.

The UE 2 may be configured to determine when the server status returns to a normal fully operative state in which the communication attempts no longer need to be reduced. In response to determining that the third party server 19 has returned to a server status which corresponds to a normal, fully operative state, the UE 2 may transmit information on the server status by device-to-device communication. The UE 2 may generate a device-to-device communication message which includes information on the server status and which causes the at least one further UE 3, 4 to resume normal communication with the third party server 19.

The at least one further UE 3, 4 may be configured to adjust communication over the network connection with the third party server 19 in response to a device-to-device communication message from the UE 2 which includes information on the server status. The at least one further UE 3, 4 may selectively increase or decrease the rate at which data are transmitted to the third party server 19 and/or the amount of data which are transmitted to the third party server 19. For illustration, a rate at which the further UE 3 pings the third party server 19 may be decreased in response to a device-to-device communication message from the UE 2 which indicates that the server status corresponds to a server failure or that there is a congestion situation.

When the at least one further UE 3, 4 receives a device-to-device communication message from the UE 2 which indicates that the server status corresponds to a server failure or a server congestion, the at least one further UE 3, 4 may start a timer. At timeout of the timer, the at least one further UE 3, 4 may revert to normal communication with the third party server unless it receives another device-to-device communication message which indicates that the third party server 19 still has a server status which makes it desirable that communication attempts are reduced. This procedure allows the at least one further UE 3, 4 to revert to normal communication with the third party server 19 even when the UE 2 is no longer positioned in proximity to the at least one further UE 3, 4 and/or even when the UE 2 has moved out of coverage of the cellular network 10.

When the at least one further UE 3, 4 receives a device-to-device communication message from the UE 2 which indicates that the server status corresponds to a normal, fully operative state, the at least one further UE 3, 4 may increase the rate at which ping signals or other messages are sent to the third party server 19 again.

Various alterations and modifications may be implemented. For illustration, a further UE 3 may receive device-to-device communication messages which include information on a server status not only from one, but from several UEs. Each device-to-device communication message may include time information, e.g. a time stamp generated by the transmitting UE, which allows the further UE 3 to reliably identify the device-to-device communication message which includes the most recent information on the server status.

At least some of the device-to-device communication messages may include a replacement identifier which informs the further UE 3 which previous information on the server status is updated by the respective device-to-device communication message. The UE 2 transmitting the device-to-device communication message may update the previous information on the server status transmitted by the UE 2 itself or by another UE by device-to-device communication. The UE 2 may include a replacement identifier in the device-to-device communication message which indicates which previous information on the server status is to be updated.

At least some of the device-to-device communication messages may include an application identifier which identifies the application(s) to which the information on the server status applies. The application identifier may be a unique identifier for the application. More than one application identifier may be included in the device-to-device communication message, e.g. when the third party server 19 supports execution or otherwise interacts with several different applications. The UE 2 transmitting the device-to-device communication message may include at least one application identifier in the device-to-device communication message. The at least one further UE 3, 4 may determine whether it presently executes the application identified by the application identifier and may selectively adjust traffic to the third party server 19 only if it executes the respective application identified by the application identifier.

The device-to-device communication message generated and transmitted by the UE 2 may be a one-to-many message. The device-to-device communication message generated and transmitted by the UE 2 may be configured such that it is received and broadcast by several further UEs 3, 4.

In any one of the various embodiments, the information on the server status may be a server status code. The server status code may have a value selected from a set of pre-defined values which correspond to different server statuses. The pre-defined values may include a value indicative of a server failure. The pre-defined values may include a value indicative of a server congestion.

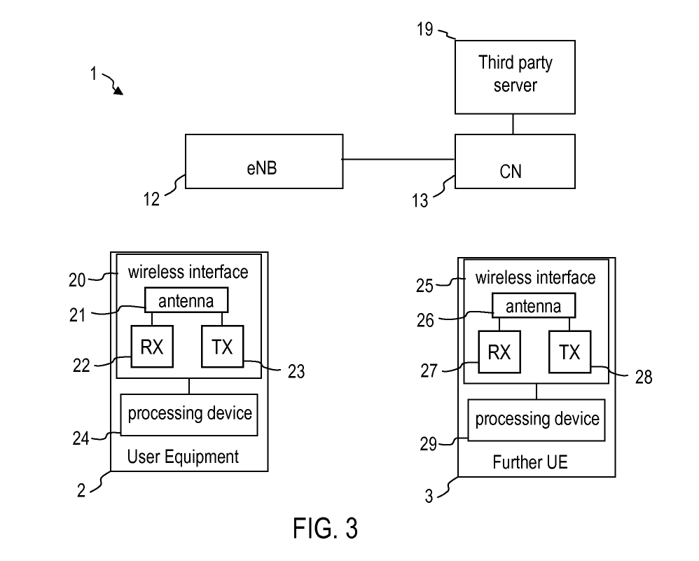

FIG. 3 is a schematic block diagram of a communication system 1 according to an embodiment. The base station 11 of the RAN is connected to a node of the RAN or the core network (CN) 13. The third party server 19 is not under the control of the cellular network operator. The third party server 19 may be connected to the internet or another wide area network.

The UE 2 has a wireless interface 20. The wireless interface 20 may be configured to communicate with the RAN 10. The wireless interface 20 may be configured for communication over the E-UTRA air interface.

The UE 2 has a processing device 24 connected to the wireless interface 20. The processing device 24 may comprise one or several microprocessors, one or several microcontroller, one or several processors, one or several control devices, one or several application specific integrated circuits (ASICs) and/or a combination of such devices. The processing device 24 may be configured to control the wireless interface 20 to detect a further UE 3 located in proximity to the UE 2. The processing device 24 may be configured to control the wireless interface 20 to perform a D2D discovery. The processing device 24 may be configured to control a transmitter path 23 of the wireless interface 20 to transmit a signal to the further UE 3 via an antenna 21 to indicate that the UE 2 is looking for a further UE for D2D communication and/or to indicate that the UE 2 would be capable of performing D2D communication. The processing device 24 may be coupled to a receiver path 22 of the wireless interface 20 to process a device-to-device discovery signal received from the further UE 3.

The processing device 24 may be configured to monitor a message received at the wireless interface 20 which includes an indicator for a server status of the third party server 19. The message may be a message generated by the third party server 19 itself. The message may be a message generated by a cellular network node of the cellular network which is aware of the server status of the third party server 19.

The processing device 24 may determine whether the UE 2 is to inform the further UE 3 of the server status. The processing device 24 may be configured to control the UE 2 such that information on the server status is distributed to the at least one further UE 3 by device-to-device communication at least when the server status is abnormal, e.g. when the third party server 19 has a server failure or when the third party server 19 experiences congestion or when the third party server 19 is unable to respond to the at least one further UE 3 for other reasons.

The processing device 24 may control the wireless interface 20 to generate and transmit a device-to-device communication message. The device-to-device communication message includes information on a server status. The processing device 24 may control the wireless interface 20 to generate the device-to-device communication message as a one-to-one message addressed to only one further UE. The processing device 24 may transmit several one-to-one messages to inform several further UEs of the server status. The processing device 24 may control the wireless interface 20 to generate the device-to-device communication message as a one-to-many message.

The processing device 24 may control generation of the device-to-device communication message such that one or several of the following is included therein: a server status code indicative of the server status; an application identifier identifying the application(s) affected by the server status; a time information, e.g. a time stamp; and/or a replacement identifier identifying which previous information is replaced by the device-to-device communication message.

The further UE 3 has a wireless interface 25 including an antenna 26, a receiver path 27, and a transmitter path 28, and a processing device 29. These entities may be configured in the same way as explained for the UE 2. In particular, the wireless interface 25 may be configured to communicate with the RAN 10. The wireless interface 25 may be configured for communication over the E-UTRA air interface. The wireless interface 25 may further be configured for D2D discovery and communication with the wireless interface 20 of the UE 2. The processing device 29 of the further UE 3 may be configured to control the wireless interface 25 to transmit D2D discovery signals.

In response to receiving a device-to-device communication message from the UE 2, the further UE 3 will adhere to the information on the server status which is indicated by the device-to-device communication message. The further UE 3 may selectively reduce the communication attempts with the third party server 19 if the device-to-device communication message indicates reduced availability or unavailability of the third party server 19. The further UE 3 may adhere to the information on the server status which is indicated by the device-to-device communication message until a further device-to-device communication message is received which indicates that the third party server 19 is available again. Other triggers may additionally or alternatively be used to cause the further UE 3 to resume normal communication with the third party server. For illustration, expiry of a timer may be monitored. The timer may be started when the device-to-device communication message is received from the UE 2. Alternatively or additionally, the further UE 3 may be informed of changes in the status of the third party server 19 also by messages received from the third party server 19 or a cellular network node.

The processing device 29 of the further UE 3 may be configured to retrieve an application identifier from the device-to-device communication message. The processing device 29 may be configured to control communication attempts between the further UE 3 and the third party server in accordance with the server status indicated by the device-to-device communication message selectively only if the further UE 3 executes the application defined by the application identifier.

The processing device 29 of the further UE 3 may be configured to retrieve a time information from the device-to-device communication message. The processing device 29 may be configured to determine based on the time information whether the information on the server status indicated by the device-to-device communication message is the most recent information on the server status available. For illustration, another UE different from the UE 2 may have previously transmitted a device-to-device communication message which includes even more recent information on the server status.

The processing device 29 of the further UE 3 may be configured to retrieve a replacement identifier from the device-to-device communication message. The processing device 29 may determine which previously received information on the server status is to be replaced by the information on the server status indicated by the device-to-device communication message. The previous information on the server status may be received from the same UE 2 or from another UE different from the UE 2.

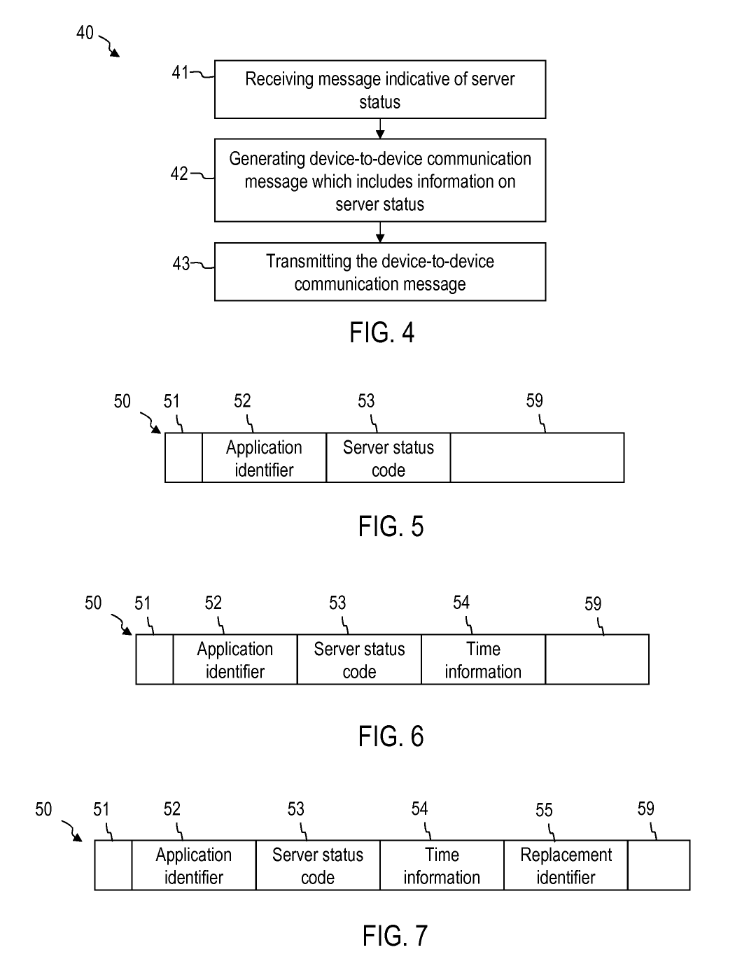

FIG. 4 is a flow chart of a method 40 according to an embodiment. The method may be performed by the UE 2.

At 41, the UE receives a message indicating on a server status. The UE may actively poll the third party server to receive the message indicating the server status. The message may be generated by the third party server itself. The message may be generated by a cellular network node which is aware of the status of the third party server.

At 42, the UE may generate a device-to-device communication message which includes information on the server status. The device-to-device communication message may include a server status code or other identifier for the server status. The device-to-device communication message may include an application identifier identifying at least one application which interacts with the third party server and which may be affected by a temporary unavailability or a temporary reduction in availability of the third party server.

At 43, the UE may transmit the device-to-device communication message which includes the information on the server status. The UE may transmit the device-to-device communication message to at least one further UE as one-to-one or one-to-many communication.

In response to receiving the device-to-device communication message, the further UE 3, 4 which executes the application affected by temporary unavailability or a temporary reduction in availability of the third party server may modify the communication with the third party server. For illustration, the rate at which the further UE 3, 4 may transmit to the third party server may be reduced. The further UE 3, 4 may adhere to the received information on the server status until a timer expires or until updated information on the server status becomes available.

FIG. 5 is a diagram which illustrates a message 50 which may be transmitted by the UE 2 to provide information on the server status of the third party server. The message 50 may be a device-to-device message which is transmitted in at least one resource block of the cellular network. The message 50 may be a one-to-one or one-to-many message.

The message 50 may include a message header 51. The message 50 may include information on a server status. The information on the server status may be or may comprise a server status code 53. The server status code may be set to one value selected from a pre-defined set of values. At least one value may be assigned to a server which is unavailable. At least another value may be assigned to a server which has reduced availability, e.g. due to a congestion.

The message 50 may include an application identifier 52. The application identifier 52 may identify at least one application which is supported by the third party server. The application identifier 52 may identify several applications which are supported by the third party server in the sense that execution of the application causes the further UE 3, 4 to communicate with the third party server.

Additional information may optionally be included in the message 50. For illustration, a validity time of the message 50 may be included as additional information 50.

FIG. 6 is a diagram which illustrates a message 50 which may be transmitted by the UE 2 to provide information on the server status of the third party server. The message may include time information 54. The time information 54 may be a time stamp. The time stamp may indicate a time for which the third party server status was detected. The further UE 3, 4 may use the time stamp to determine the most recent information on the server status from among several received device-to-device communication messages. For illustration, the further UE 3 may receive different information on the server status from a UE 2 and another UE. The further UE 3 may identify the most recent information on the server status based on the time stamps.

Alternatively or additionally, the time information 54 may include a validity time. For illustration, the UE 2 may be configured to transmit updated information on the sever status after a time interval. The validity time may be set to be equal to the time interval. The further UE 3 may set a timer in dependence on the validity time. If the UE 2 does not send updated information on the server status, the further UE 3 may revert to normal communication with the third party server, e.g. resuming pinging.

FIG. 7 is a diagram which illustrates a message 50 which may be transmitted by the UE 2 to provide information on the server status of the third party server. The message may include a replacement identifier 55. The replacement identifier 55 may identify which previously transmitted information on the server status is replaced by the server status information 53 in the message 50.

The UE 2 which transmits the message 50 may replace a previous information on the server status which was transmitted by the UE 2 itself. The UE 2 which transmits the message 50 may replace a previous information on the server status which was transmitted by another UE different from the UE 2. The replacement identifier 55 may be a unique identifier for a previous device-to-device communication message to indicate which previous server status information is replaced.

While exemplary information elements for inclusion in the device-to-device communication message 50 have been described with reference to FIG. 5 to FIG. 7, alternative or additional information elements may be included in the device-to-device communication message 50 in other implementations. Some of the information elements may also be omitted.

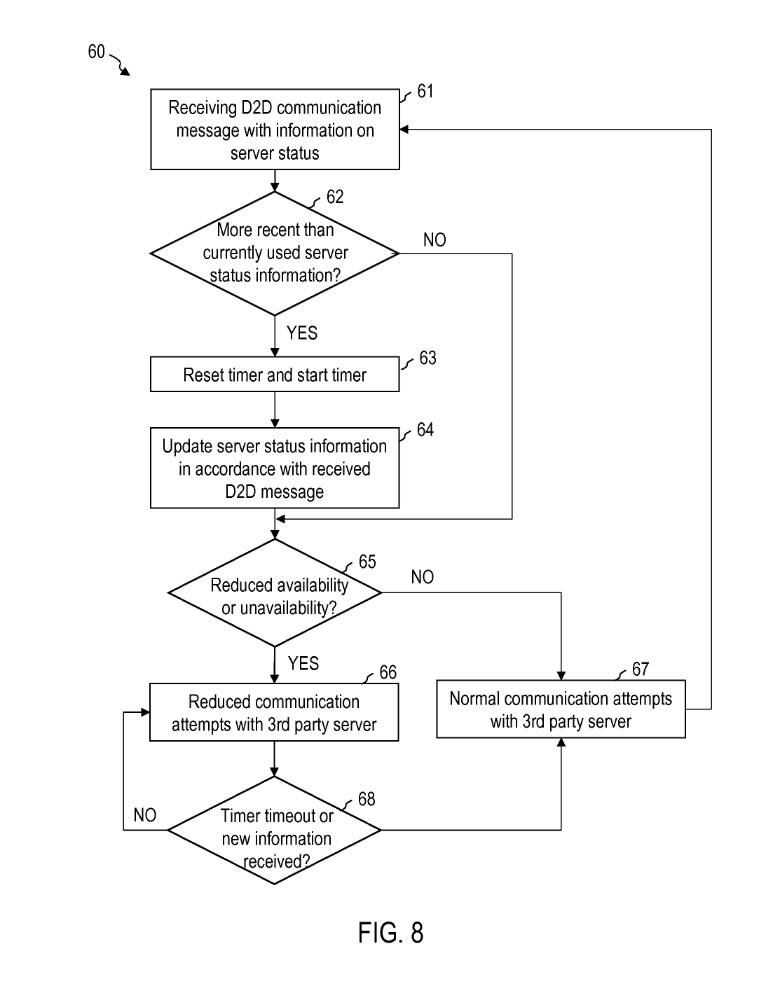

FIG. 8 is a flow chart of a method 60. The method 60 may be performed by a further UE according to an embodiment, it being understood that the term “further UE” as used herein refers to a UE which receives information on the server status by device-to-device communication.

At 61, the further UE receives a device-to-device communication message from the UE. The device-to-device communication message includes information on a server status of a third party server. The information may indicate whether the third party server is unavailable or has reduced availability.

The device-to-device communication message may include identifier(s) for application(s) which interact with the third party server. The further UE may selectively continue the processing which will be explained in more detail below only if it executes an application which is affected by the third party server.

Generally, the further UE will adhere to the information on the server status received in the device-to-device communication message and may adjust its communication with the third party server over a network connection accordingly. The further UE may adhere to the information on the server status until updated information on the server status is available or a timer expires.

At 62, the further UE determines whether the received information on the server status is more recent than any previously received information on the server status for the same third party server and the same application. If the information on the server status is not more recent than previously received information, the device-to-device communication message may be discarded and the method may proceed to step 65. In this case, the previous information on the serve status, which may have been relayed by another UE, for example, provides information on the server status which is more likely to represent the current server status. A time stamp included in the device-to-device communication message may be evaluated to determine whether the information on the server status is the most recent information on the server status which is available to the UE.

At 63, if the device-to-device communication includes the most recent information on the server status which is available to the further UE, a timer may be reset and started. The timer may be set to a pre-defined value. The timer may be set in dependence on time information in the device-to-device communication message. The time information may be set in dependence on a time interval at which the UE is expected to transmit updated information on the server status.

At 64, the further UE may update a record of the server status. By default, the further UE may set the status information to a state which indicates that the third party server is available for communication. If the information in the received device-to-device communication message indicates that the server is unavailable or has reduced availability for responding to requests from the further UE, the further UE may update the server status information accordingly. If the server status record maintained by the further UE is presently set to indicate that the third party server is unavailable or has reduced availability, the further UE may update the server status to indicate that the third party server is available if this is indicated by the device-to-device communication message.

At 65, the further UE determines whether the server status indicates that the third party server is unavailable or has reduced availability.

At 66, if the further UE determines that the server status indicates that the third party server is unavailable or has reduced availability, the further UE may reduce communication attempts with the third party server. This may include temporarily suspending all communication to the third party server with the exception of acknowledgments. Step 66 may include increasing a time interval between successive transmissions to the third party server. Step 66 may include decreasing a rate at which pinging is performed.

At 68, the further UE may monitor a trigger which causes the further UE to revert to non-reduced communication with the third party server. The trigger may be expiry of the timer. The trigger may be receipt of updated information on the server status from the UE 2 or another UE or the cellular network. If the trigger for terminating the reduced communication is not detected, the further UE may continue to operate at 66 in a manner in which the communication attempts with the third party server are reduced.

At 67, if the server is available or the trigger is detected at 68, the further UE operates such that the communication attempts to the third party server are no longer reduced.

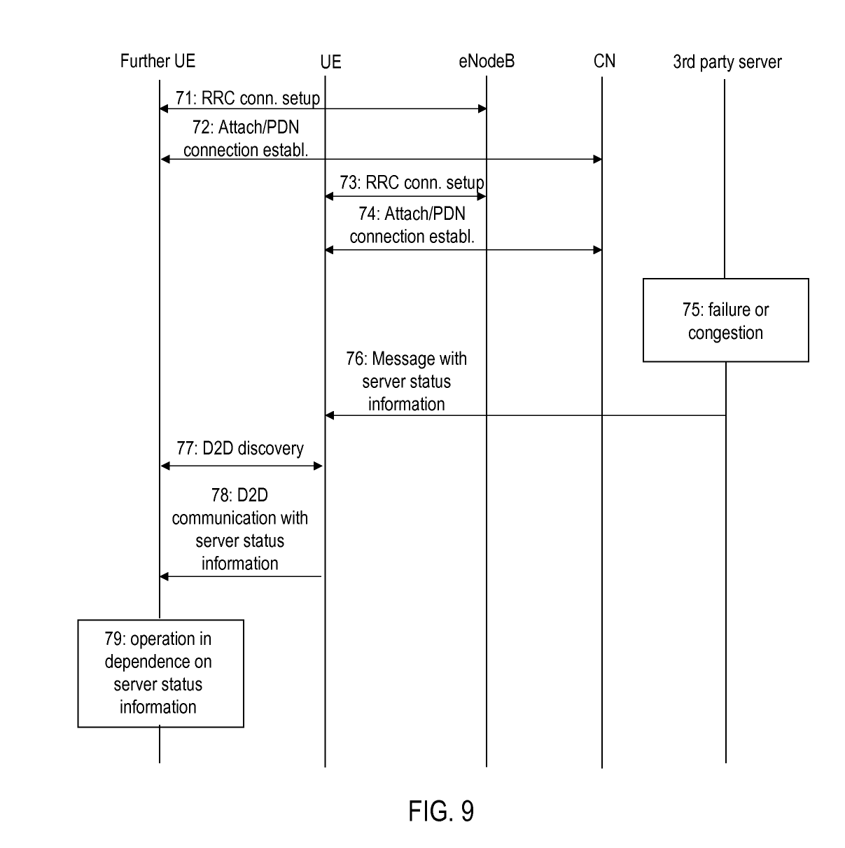

FIG. 9 is a diagram which shows signaling in a communication system according to an embodiment. The signaling may be used when the UE provides information on a server status to at least one further UE.

The UE and the further UE may be attached to a cellular network. A conventional attachment procedure may be performed. The further UE may perform a connection setup. For illustration, the signaling of a Radio Resource Control (RRC) connection setup 71 may be performed. The further UE may perform an attach/packet data network (PDN) connection establishment 72. Similarly, the UE may perform a RRC connection setup 73 and an attach/PDN connection establishment 74.

A network connection may be established between the UE and the third party server over which data transmission takes place when the UE executes an application. A network connection may be established between the further UE and the third party server over which data transmission takes place when the U further E executes the application. At 75, the availability of the third party server is reduced or the third party server becomes unavailable. For illustration, a server failure or a congestion may occur.

A message 76 including information on the server status may be transmitted to the UE. The message 76 may include a server status code. The server status code may indicate whether the third party server is unavailable, has reduced availability or is fully available for assisting the UE and the further UE in the execution of the application.

The message 76 does not need to be transmitted by the third party server itself. For illustration, there may be situations such as server failure in which the third party server may not be capable of transmitting the message 76. A cellular network node of the cellular network may transmit the message 76 to the UE.

The message 76 does not need to be transmitted to both the UE and the further UE. The third party server or the cellular network node may transmit the message 76 to only a sub-set of a group of terminals which execute the application. The sub-set may be selected based on proximity information, which may be reported by the UE and the further UE to the cellular network.

A device-to-device discovery 77 may be performed. The device-to-device discovery 77 may be performed in response to receipt of the message 76. The UE may transmit a device-to-device discovery signal indicating that it looks for a device-to-device communication partner.

A device-to-device communication message78 is transmitted which includes information on the server status. The device-to-device communication message78 may include one or several of an application identifier identifying the application(s) affected by the status of the third party server; a time stamp or other time information; a replacement identifier; a message header; a hop counter; and/or message payload.

In response to the device-to-device communication message 78, the further UE operates in a mode 79 in which it adheres to the information on the server status included in the device-to-device communication message 78. In the mode 79, the application executed on the further UE may be limited or completely prevented from contacting the third party server. Receipt of updated information on the server status and/or expiry of a timer may cause the further UE to terminate the mode 79 and to revert to an operating mode in which the application on the further UE is no longer prevented from contacting the third party server.

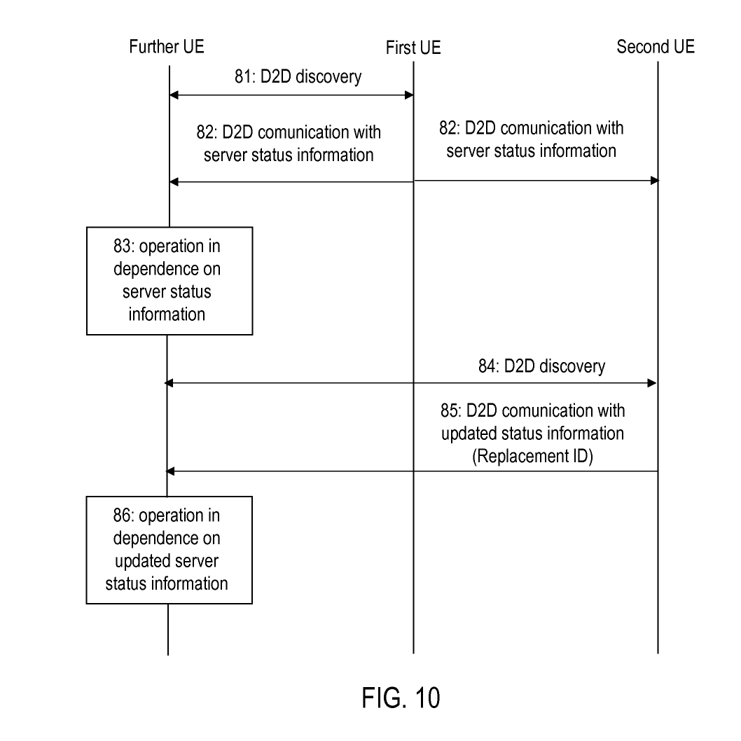

FIG. 10 is a diagram which shows signaling in a communication system according to an embodiment. The signaling may be used when both a first UE and a second UE provides information on a server status to at least one further UE. The first UE, the second UE and the at least one further UE may all be attached to the cellular network as explained with reference to 71-74 in FIG. 9. Each one of the first UE, the second UE and the at least one further UE may execute an application which interacts with the third party server.

The first UE may transmit information on the server status of the third party server to the further UE by device-to-device communication. The first UE may perform a device-to-device discovery 81 to detect the further UE in proximity to the first UE. The first UE may generate and transmit a device-to-device communication message 82 to the further UE. The device-to-device communication message 82 includes information on the server status and may include additional information, e.g. a time stamp or other time information.

The device-to-device communication message 82 may also be received by the second UE and any other ProSe-enabled UE in a proximity range of the first UE.

In response to the device-to-device communication message 82, the further UE operates in a mode 83 in which it adheres to the information on the server status included in the device-to-device communication message 82. In the mode 83, the application executed on the further UE may be limited or completely prevented from contacting the third party server if the device-to-device communication message 82 indicates that the third party server is unavailable or has reduced availability.

The second UE may subsequently provide updated information on the server status to the further UE. The second UE may perform a device-to-device discovery 84 to detect the further UE in proximity to the second UE. The second UE may generate and transmit a further device-to-device communication message 85 to the further UE. The further device-to-device communication message 85 includes updated information on the server status and may include additional information, e.g. a time stamp or other time information. The further device-to-device communication message 85 may include a replacement identifier which indicates that the further device-to-device communication message 85 includes updated information on the server status which replaces the information on the server status included in the earlier device-to-device communication message 83.

In response to the further device-to-device communication message 85, the further UE operates in a mode 86 in which it adheres to the information on the server status included in the further device-to-device communication message 86. For illustration, if the updated information on the server status in the further device-to-device communication message 85 indicates that the server is available again, the further UE may terminate the mode 83 in which communication attempts to the third party server are decreased and may operate in a normal mode 86 in which the application is permitted to contact the third party server.

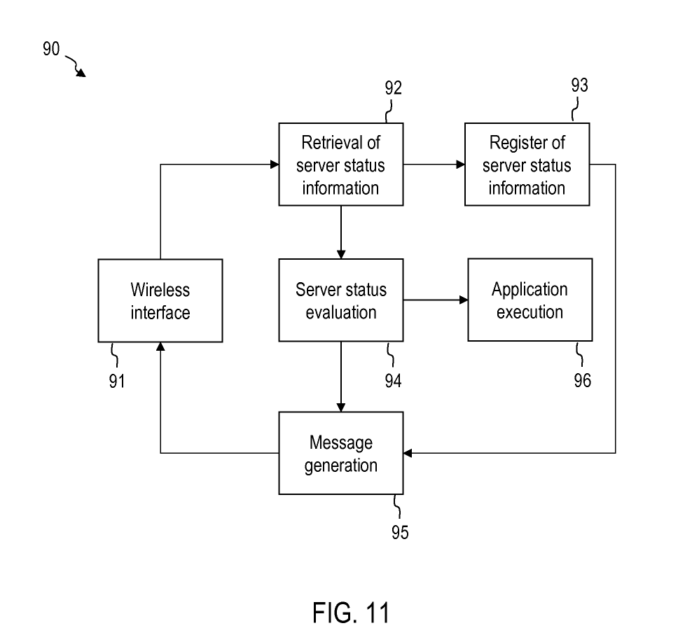

FIG. 11 is a functional block diagram of a UE 90 according to an embodiment.

The UE 90 comprises a wireless interface 91 for communication with a cellular network. The wireless interface 91 may be used for receiving a message through the cellular network which includes an indication for a server status. The wireless interface 91 may be used for transmitting a device-to-device communication message with information on the server status to at least one further UE, using cellular network resources.

The UE 90 may comprise a retrieval module 92 for retrieving server status information from a message received at the wireless interface 91.

The UE 90 may comprise a storage module 93 which stores current and optionally also historical information on the server status of the third party server. Receipt of a message which includes server status information may trigger the UE 90 to store the information on the server status, e.g. a status code, in the storage module 90.

The UE 90 may comprise a server status evaluation module 94. The server status evaluation module 94 may be configured to determine whether the server status changed in a way which causes the UE 90 to relay the information on the server status to at least one further UE. The server status evaluation module 94 may be configured to determine whether the server status is such that at least one further UE shall reduce communication attempts with the third party server.

The UE 90 may comprise an application execution module 96 configured to control execution of the application which interacts with the third party server. The application execution module 96 may limit the rate of transmissions and/or data amount transmitted to the third party server if the server status indicates that the third party server has reduced availability or is unavailable.

The UE 90 may comprise a message generation module 95. The message generation module 95 may be configured to cause the wireless interface 91 to transmit a device-to-device communication message which includes information on the server status. The device-to-device communication message may be transmitted over the same interface over which the UE 90 communicates with the cellular network. The device-to-device communication message may include any one of the information elements described with reference to FIG. 1 to FIG. 10 above.

Modifications or alterations may be implemented in other embodiments. For illustration, the UE may determine the server status without requiring receipt of a message which includes the information on the server status to the UE. The UE may monitor response times of the third party server to determine whether the third party server has limited availability, e.g. due to a congestion situation.

For further illustration, additional or alternative information may be included in the device-to-device communication message. The device-to-device communication message may include a hop counter which indicates by how many UEs the information on the server status is forwarded. The hop counter may provide information on the time delay which may be associated with the transmission of the status information. A UE which relays the status information may increment the hop counter. A series of two or more UEs may relay the server status information before the server status information is received by the further UE.

In any one of the various embodiments, the UE and/or the further UE may be machine communication terminals. The machine communication terminals may be configured such that they do not comprise a user interface. In any one of the various embodiments, the UE and/or the further UE may be mobile phones or other portable communication terminals which have a user interface.

Embodiments of the invention allow a UE to indicate to one or more further UEs to reduce or temporarily suspend communication with a third party server, thereby distributing information on the server status and mitigating problems associated with high network loads.

What is claimed is:

1. A method of providing information on a server status of a third party server by a user equipment of a cellular network, the method comprising:
determining, by the user equipment, the server status of the third party server; and
transmitting, by the user equipment, the information on the server status to at least one further user equipment by device-to-device communication.

2. The method of claim 1,
wherein the user equipment comprises a wireless interface for communication with the cellular network;
wherein determining the server status by the user equipment comprises:
receiving, by the user equipment, a message indicative of the server status at the wireless interface; and
wherein the user equipment transmits the information on the server status to the at least one further user equipment over the wireless interface.

3. The method of claim 2,
wherein the message is indicative of at least one of a congestion or a failure of the third party server.

4. The method of claim 2,
wherein the user equipment interacts with the third party server for executing an application.

5. The method of claim 4,
wherein the user equipment transmits an identifier for the application to the at least one further user equipment by the device-to-device communication.

6. The method of claim 2,
wherein the message is generated by the third party server.

7. The method of claim 2,
wherein the message is generated by a cellular network node.

8. The method of claim 2,
wherein the user equipment relays at least one information element of the received message as the information on the server status to the at least one further user equipment by the device-to-device communication.

9. The method of claim 1,
wherein transmitting the information on the server status comprises:
generating and transmitting, by the user equipment, a device-to-device communication message which includes time information and the information on the server status.

10. The method of claim 9,
wherein the at least one further user equipment selectively reduces communication attempts to the third party server based on the time information and the information on the server status.

11. The method of claim 9,
wherein the user equipment determines whether the information on the server status is to replace a previous information on the server status which was previously transmitted to the at least one further user equipment; and
wherein the user equipment includes a replacement identifier identifying the previous information in the device-to-device communication message.

12. The method of claim 1,
wherein the user equipment is a machine-communication terminal.

13. A user equipment configured to interact with a third party server through a cellular network, comprising:
a wireless interface for communication with the cellular network; and
a processing device to control the wireless interface to provide information on a server status of the third party server to at least one further user equipment by device-to-device communication.

14. The user equipment of claim 13,
wherein the server status comprises a server failure status of the third party server.

15. The user equipment of claim 13,
wherein the wireless interface is operative to receive a message indicative of the server status; and
wherein the processing device is operative to control the wireless interface to transmit the information on the server status to the at least one further user equipment over the wireless interface by device-to-device communication.

16. The user equipment of claim 15,
wherein the user equipment relays at least one information element of the received message as the information on the server status to the at least one further user equipment by the device-to-device communication

17. The user equipment of claim 13,
wherein the user equipment determines whether the information on the server status is to replace a previous information on the server status which was previously transmitted to the at least one further user equipment; and
wherein the user equipment selectively includes a replacement identifier identifying the previous information in a device-to-device communication message.

18. The user equipment of claim 13,
wherein the processing device is configured to generate a device-to-device communication message which includes time information and the information on the server status.

19. A communication system, comprising:
a first user equipment; and
a second user equipment;
wherein the first user equipment comprises
a wireless interface for communication with a cellular network; and
a processing device configured to control the wireless interface to provide information on a server status of the third party server to the second user equipment by device-to-device communication;
wherein the second user equipment comprises a further wireless interface for communication with the cellular network, the second user equipment being configured to receive the information on the server status at the further wireless interface and to control communication attempts with the third party server in dependence on the received information on the server status.

20. The communication system of claim 19,
wherein the second user equipment is configured to adjust a time interval between successive communication attempts with the third party server in dependence on the information on the server status.
